(19) United States
(12) Patent Application Publication
(10) Pub. No.: US 2010/0103662 A1
(43) Pub. Date: Apr. 29, 2010

(54) Pixel Support System

(75) Inventor: Christopher Varrin, Los Gatos, CA (US)

Correspondence Address: AKA CHAN LLP, 900 LAFAYETTE STREET, SUITE 710, SANTA CLARA, CA, 95050, US

(73) Assignee: ELEMENT LABS, INC., Santa Clara, CA (US)

(21) Appl. No.: 12/530,170

(22) PCT Filed: Nov. 30, 2007
(86) PCT No.: PCT/US07/86168

§ 371 Date: Sep. 4, 2009

Related U.S. Application Data
(60) Provisional application No. 60/868,283, filed on Dec. 1, 2006.

(51) Int. Cl. F21V 9/00; F21V 21/00; F21S 2/00; H05B 37/02; H01J 9/00

(52) U.S. Cl. 362/231; 362/382; 362/227; 315/294; 362/397; 362/398; 445/24

(57) ABSTRACT

A light emitting pixel module including a pixel support disposed on a support structure, and a light emitting element and an electrical connector disposed upon the pixel support, in which the support structure is configured to be removeably attached to a display surface such that light emitted from the light emitting element is viewable from or through the substrate.

### CROSS-REFERENCE TO RELATED APPLICATIONS

This application claims benefit of U.S. Provisional Application Ser. No. 60/868,283 filed on Dec. 1, 2006 and entitled “Pixel Support System” in the name of Chris Varrin.

### BACKGROUND

1. Field of the Disclosure

Embodiments disclosed herein generally relate to light emitting apparatuses and light emitting systems. More specifically, embodiments disclosed herein relate to an improved light emitting apparatus with pixels for use in various industries.

2. Background Art

Display units for entertainment, architectural, and advertising purposes have commonly been constructed from numbers of light emitting elements such as light emitting diodes (“LEDs”) or incandescent lamps mounted onto flat panels. The light emitting elements can be selectively turned on and off to create patterns, graphics and video displays for both informational and aesthetic purposes. It is well known to construct these displays as tiles or large panels which are assembled in position for a specific entertainment show or event or as an architectural or advertising display. Examples of such systems are disclosed in U.S. Pat. Nos. 6,813,853, 6,704,989 and 6,314,669.

As the LED video market expands into new domains, the classic fixed structure of the LED video panel may become a limitation. Designers, architects, and advertisers may desire the flexibility and versatility to use only one or a few products within the rapidly changing environment of the modern era. For example, a panel or modular box system may work well in a stadium score board or as an advertisement on the Las Vegas Strip, but the large panels may have limitations on transparency and weight.

As such, there may be a requirement at an event or within a theatrical production to use a display system that is easily removable, for example, in between scenes of a play or as the needs of the production may dictate. A display apparatus constructed as a large panel or as a series of solid tiles bolted or permanently fixed together may be very inappropriate for such an application or need. The displays may be large and heavy, and require abundant support machinery, time, and storage space for installation. For example, as disclosed in U.S. Pat. No. 6,704,989, issued to Lutz, an electronic signal display system requires the individual display sections be lifted out of storage cases with a lifting truss and then joined and stacked appropriately for display.

To improve upon these limitations, as described above, many existing products are being developed with a degree of transparency and to weigh less than their panel based counterparts. An example of such a prior art display apparatus is disclosed in U.S. Pat. No. 6,237,290, issued to Tokimoto et al.

Tokimoto et al discloses a system that effectively integrates the electronic and structural components for use in a building. In this case, the LED ribs are incorporated into a void in the glass wall of the building. However, there may be limitations to the method disclosed in Tokimoto et al. For example, maintaining the system within the void is complicated. The system disclosed by Tokimoto et al could be used to back light a graphic on the glass exterior, however, issues with line of sight would prevent the system from acting as a part of the graphic. This may be the result in the alignment of the system and the graphic shifting as the viewer moves. Further, the system may not function as a finished surface.

Another requirement for display systems used for events, such as theatrical productions, is for the display to take up a minimal amount of storage space when stored. In addition, there is a need for a display system that is easily and quickly configurable to multiple sizes and shapes, thereby allowing the system to suit different installations and logistical constraints. To meet this need, flexible substrate based displays have been created, in which the light emitting elements are incorporated into a webbing or fabric curtain. Examples of these prior art displays are disclosed in U.S. Pat. No. 5,900,850, U.S. Pat. No. 6,362,801, U.S. Pat. No. 6,677,918, UK Patent No. GB 2,277,797 and UK Patent No. GB 2,330,196. Prior art systems of this kind, constrain the user to a fixed and specific pixel spacing in the vertical direction, the horizontal direction, or both. None of these systems are completely and independently configurable in all dimensions. In addition, all these prior art systems require a specific supporting structure of some kind. For example, the supporting structure may be a grid support, a trussing support, or the display may be affixed to a building. As such, these systems may be limited to riot intrinsically and separately attach to an existing and unmodified structure. Accordingly, there exists a need for a display apparatus and a display system that improves upon these prior art displays for continued development and success within the various light emitting industries.

### SUMMARY OF THE DISCLOSURE

In one aspect, embodiments disclosed herein relate to a light emitting pixel module comprising a pixel support disposed on a support structure, and a light emitting element and a electrical connector disposed upon the pixel support, wherein the support structure is removeably attached to a display surface of a substrate such that light emitted from the light emitting element is viewable from or through the substrate.

In another aspect, embodiments disclosed herein relate to a light emitting display system including a plurality of light emitting pixel modules, each of the plurality of light emitting pixel modules including, a support structure removeably attached to a display surface, a light emitting element mounted on a pixel support, the pixel support disposed on the support structure, and an electrical connector disposed on the pixel support, wherein the plurality of the light emitting pixel modules are arranged in a configurable display on the display surface.

In yet another aspect, embodiments disclosed herein relate to a method of attaching a light emitting element to a display surface including providing a pixel module having a light emitting element disposed on a pixel support and the pixel support mounted on a support structure, and removeably attaching the pixel module to the display surface such that light emitted from the light emitting element is viewable from the display surface.

Further, in yet another aspect, embodiments disclosed herein relate to a method of manufacturing a pixel module including electrically connecting and attaching a light emitting element and an electrical connector to a pixel support, and attaching the pixel support to a support structure, wherein the support structure is configured to be removeably attached to a display surface.

Furthermore, in yet another aspect, embodiment disclosed herein relate to a light emitting pixel module including a pixel support disposed on a support structure, and a light emitting element and an electrical connector disposed upon the pixel support, wherein the support structure comprises one of a suction cup, an adhesive support structure, a mechanical support structure, a static cling support structure, and a magnetic support structure, and wherein the support structure is removeably attached to a display surface.

Other aspects and advantages of the present disclosure will be apparent from the following description and the appended claims.

### BRIEF DESCRIPTION OF DRAWINGS

FIG. 1 shows a plan detail view of a light emitting pixel module in accordance with an embodiment of the present disclosure.

FIG. 2 shows a cross-sectional view of a light emitting pixel module in accordance with an embodiment of the present disclosure.

FIG. 3 shows a cross-sectional view of a light emitting pixel module in accordance with an embodiment of the present disclosure.

FIG. 4 shows a cross-sectional view of a light emitting pixel module in accordance with an embodiment of the present disclosure.

FIG. 5 shows a cross-sectional view of a light emitting pixel module in accordance with an embodiment of the present disclosure.

FIG. 6 shows a cross-sectional view of a light emitting pixel module attached to a substrate in accordance with an embodiment of the present disclosure.

FIG. 7 shows a cross-sectional view of a light emitting pixel module in accordance with an embodiment of the present disclosure.

FIG. 8 shows a perspective view of a light emitting display system having multiple light emitting pixel modules mounted to a substrate in accordance with an embodiment of the present disclosure.

FIG. 9 shows a cross-sectional view of a light emitting pixel module attached to a substrate in accordance with an embodiment of the present disclosure.

### DETAILED DESCRIPTION

Specific embodiments of the present invention will now be described in detail with reference to the accompanying figures. Like elements in the various figures may be denoted by like reference numerals for consistency.

In one aspect, embodiments disclosed herein generally relate to display units and particularly to the design of a pixel support mechanism (e.g., light emitting pixel module) for a configurable display system. The pixel support mechanism may provide both support and alignment of an individual light emitting element or group of light emitting elements. Further, the pixel support mechanism may include a support structure that allows the pixel support mechanism to be removeably or permanently attached to a substrate. As used herein, a “support structure” refers to any structure or device which may be, removeably or permanently, attached or secured to a surface or substrate. Furthermore, a group of pixel support mechanisms may be used to form a display system that is simple and quick to assemble or reconfigure in all dimensions.

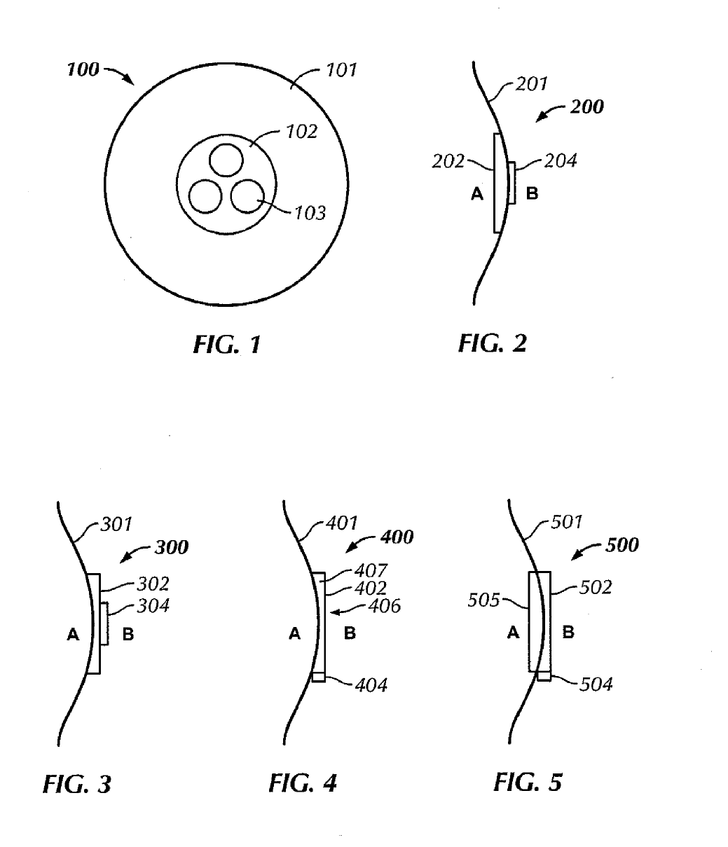

FIG. 1 shows a plan detail of a pixel module 100 in accordance with an embodiment of the present disclosure. The pixel module 100 includes a support structure 101, a pixel support 102, at least one light emitting element 103, and an electrical connector (not shown here). The pixel support 102 is mounted on the support structure 101 and the at least one light emitting element 103 is mounted to a pixel support 102. Three light emitting elements 103 are used in this embodiment, however, the embodiments disclosed herein are not so limited and any number of light emitting elements 103 may be used. For example, in another embodiment, five light emitting elements may be mounted to the pixel support. The electrical connector is connected to the pixel support 102 (discussed more below).

In addition, the at least one light emitting element 103 may also include, for example, light emitting diodes (LEDs), organic LEDs (OLEDs), polymer LEDs (PLEDs), incandescent lamps, or any other lighting elements known in the art. Therefore, in one embodiment, the at least one light emitting element 103 may include a plurality of LEDs such that light of a desired color may be emitted from each light emitting element 103. For example, the lighting elements 103 may include light emitting diodes with each diode having the same color. Further, the lighting elements 103 may include light emitting diodes, with each diode having a different color.

In one embodiment, such as FIG. 1, the support structure 101 includes a suction cup, in which the suction cup may be attached to a display surface of a substrate through a differential in air pressure between the inside of a pocket (not shown) formed between the suction cup and the display surface, and outside the pocket. Those having ordinary skill in the art will appreciate that a number of devices may be used as the support structure 101 (discussed more below).

FIG. 2 shows a cross-sectional view of a light emitting pixel module 200 in accordance with an embodiment of the present disclosure. The pixel module 200 includes a support structure 201, a pixel support 202, at least one light emitting element (not shown here), and an electrical connector 204. In this embodiment, the pixel support 202 is disposed on the “inside” of the pixel module 200, which is the same side of the support structure 201 that may be removeably attached to a display surface (not shown). Further, the electrical connector 204 may be mounted on the “outside” the pixel module 200 and connect through the support structure 201 to the pixel support 202. For example, the support structure 201 may have a thru hole in which a connection from the electrical connector 204 is fed through and connected to the pixel support 202.

The electrical connector may be a spring connector, an insulation displacement connector, or any other electrical connectors known in the art. The electrical connector is configured to transfer a data signal and power to the at least one light emitting element of the pixel module. For example, the electrical connector may be used to electrically connect the at least one light emitting element to a power supply (not shown). As such, the power supply may transfer a data signal and/or power through a wire or circuit board that may be received by the electrical connector 204. The power received by the electrical connector 204 may then be transmitted through a circuit board or electrical wires within the light emitting element to emit light. In addition, a driver circuit may be electrically connected to the light emitting elements and configured to vary an intensity of at least one light emitting element.

For example, in one embodiment, the at least one light emitting element of the pixel module 200 may be disposed on and electrically connected to a printed circuit board (PCB). In such an embodiment, the PCB may be disposed within the pixel support of the light emitting pixel module, in which the light emitting element may be disposed upon and electrically connected to the PCB. Further, the electrical connector may be electrically connected to the PCB. As such, the data signals and/or power received by the electrical connector may be transmitted through the PCB to the light emitting element, thereby enabling control of the light emitting element (e.g., selectively turn on or off, vary light intensity or color) with the data signal and power.

Referring back to FIG. 2, in this embodiment, the pixel support 202 faces “inwards” so that, when viewing from side A of the pixel module 200, light emitted from the at least one light emitting element mounted upon the pixel support 202 may be viewable. In this embodiment, Side A is the side of the pixel module 200 that is configured to attach or secure to the display surface of a substrate (not shown). However, in an alternate embodiment, the pixel module 202 may face “outwards,” when viewing from side B of the pixel module 200, which may allow light emitted from the at least one light emitting element mounted upon the pixel support 202 to be viewable.

FIG. 3 shows a cross-sectional view of a light emitting pixel module 300 in accordance with an embodiment of the present disclosure. Similar to the pixel module 200 in FIG. 2, the pixel module 300 includes a support structure 301, a pixel support 302, at least one light emitting element 303, and an electrical connector 304. However, in this embodiment, the pixel support 302 is disposed on the outside the pixel module 300, which is opposite the side of the support structure 301 that may be attached to a display surface of a substrate. The electrical connector 304 is also mounted outside the pixel module 300 and connects to the pixel support 302. The electrical connector 304 is configured to supply a data signal and power to the pixel module 300, similar to the electrical connector 204 of FIG. 2.

Further, in this embodiment, the pixel support 302 faces “inwards” so that, when viewing from side A of the pixel module 300, light emitted from a light emitting element 303 mounted upon the pixel support 302 may be viewable. Side A is the side of the pixel module 300 which is configured to attach or secure to the display surface of the substrate. However, in an alternate embodiment, the pixel module 302 may face “outwards,” when viewing from side B of the pixel module 300, which may allow light emitted from the at least one light emitting element 303 mounted upon the pixel support 302 to be viewable.

FIG. 4 shows a cross-sectional view of a light emitting pixel module 400 in accordance with an embodiment of the present disclosure. Similar to the above embodiments, the pixel module 400 includes a support structure 401, a pixel support 402, at least one light emitting element 403, and an electrical connector 404. However, in this embodiment, the pixel support 402 faces outward towards side B. Further, the electrical connector 404 may be disposed on an outer surface 407 of the pixel support 402. One skilled in the art will appreciate that this may increase the amount of lighting emitting elements 403 able to be disposed on a front surface 406 of the pixel support 402.

FIG. 5 shows a cross-sectional view of a light emitting pixel module 500 in accordance with an embodiment of the present disclosure. Similar to the above embodiments, the pixel module 500 includes a support structure 501, a pixel support 502, at least one light emitting element 503, and an electrical connector 504. However, in this embodiment, the light emitting pixel module 500 further includes a second pixel support 505 disposed on the inside of the pixel module 500. Specifically, one pixel support 502 is disposed on the outside of the support structure 501, and the second pixel support 505 is disposed on the inside of the support structure 501. In addition, the electrical connector 504 may be mounted outside the pixel module 500 and may connect to both pixel supports 502, 505. In this embodiment, the pixel support 502 faces outwards toward side B and the second pixel support 505 faces inwards toward side A. However, those having skill in the art will appreciate that the embodiments disclosed herein are not so limited, and the pixels supports may face any direction.

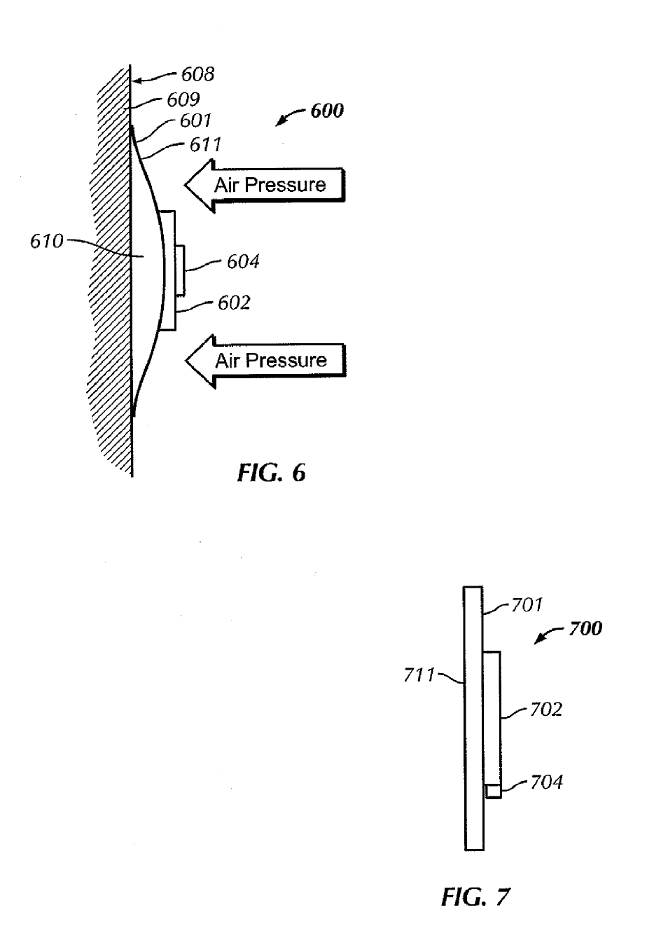

FIG. 6 shows a cross-sectional view of a light emitting pixel module 600 attached to a display surface 608 of a substrate 609 in accordance with an embodiment of the present disclosure. Similar to the embodiments above, the pixel module 600 includes a support structure 601, a pixel support 602, at least one light emitting element, and an electrical connector 604. Further, as shown, the pixel module 600 may be removeably attached to a display surface 608 of a substrate 609. The substrate 609 may be any object including, but not limited to, a wall, ceiling, window or floor constructed of wood, glass, metal, plastic or any other suitable material.

For example, in FIG. 6, the support structure 601 includes a suction cup 611 that is depressed on to the display surface 608 of the substrate 609 so as to expel the air from a pocket 610 formed between the suction cup 611 and the display surface 608. On release, the suction cup 611, and thus the pixel module 600, will remain affixed to the display surface 608 of the substrate 609 through external air pressure. After affixing the pixel module 600 to the substrate 609, an electrical connection may be made through the electrical connector 604. Further, in an alternative embodiment, though not shown, a valve and vacuum pump may be used to withdraw air from the pocket 610 formed between the suction cup 611 and the display surface 608. Specifically, in such an embodiment, the pixel module 600 may include a valve disposed thereon or attached thereto, in which the vacuum pump may connect to the valve to withdraw air from or introduce air to the pocket 610.

FIG. 7 shows a cross-sectional view of a light emitting pixel module 700 in accordance with an embodiment of the present disclosure. Similar to the above embodiments, the pixel module 700 includes a support structure 701, a pixel support 702, at least one light emitting element, and an electrical connector 704. However, in this embodiment, the support structure 701 includes an adhesive support structure 711, in which the adhesive support structure 711 may be attached to a display surface of a substrate through adhesion or grip. In such an embodiment, depending on the adhesive support structure 711, the pixel module may either removeably or permanently attached to the display surface.

Further, in an alternate embodiment, rather than having an adhesive support structure or a suction cup, or in addition to the adhesive support structure and the suction cup, the support structure 701 may include a magnetic support structure, in which the magnetic support structure attaches to a display surface or substrate through a magnetic force. For example, in FIG. 7, rather than the pixel module 700 having the adhesive support structure 711, the pixel module 700 may have a magnetic support structure 711. With a magnetic support structure, the magnetic force may be produced from an attraction between the magnetic support structure and the display surface or substrate, such as magnets within the magnetic support structure attracting to a metallic display surface or substrate. Alternatively, though, the magnetic force may be produced from an attraction between the magnetic support structure and another magnet, with the display surface or substrate therebetween. For example, the magnetic support structure may attach or secure to a piece of glass with the magnetic support structure on one side of the glass, and magnets attracting the magnetic support structure to the glass on an opposite side of the glass.

Furthermore, in yet another alternate embodiment, rather than having a suction cup, an adhesive support structure, or a magnetic support structure, the support structure may include a static cling support structure, in which the static cling support structure attaches to a display surface or substrate through a static cling (i.e., static electricity) force. For example, in FIG. 7, the pixel module 700 may have a static cling support structure 711. With a static cling support structure, the static cling or static electricity force may be produced from an attraction between the static cling support structure and the display surface or substrate. In one embodiment then, the static cling support structure may include vinyl, such as PVC, in which the PVC has a large quantity of liquid plasticizer added thereto. As such, the static cling support structure, when applied to a display surface or substrate, may adhere firmly to the display surface without the need of an adhesive material. The static cling support structure may then be removed and re-applied to other display surfaces without leaving behind any residue, such as from an adhesive material.

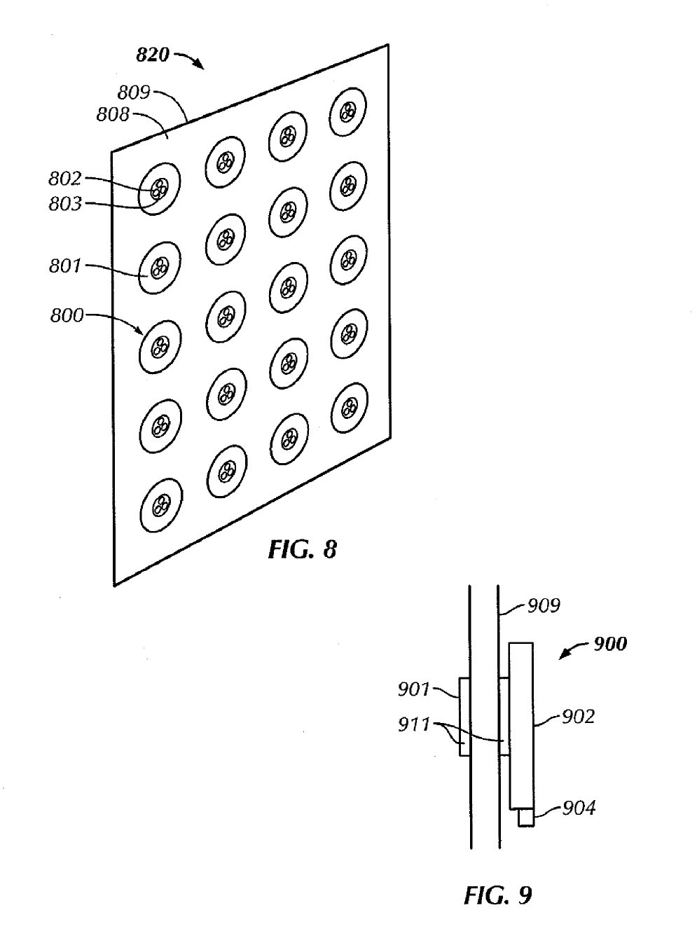

FIG. 9 shows a cross-sectional view of a light emitting pixel module 900 attached to a substrate 909 in accordance with an embodiment of the present disclosure. Similar to the above embodiments, the pixel module 900 includes a support structure 901, a pixel support 902, at least one light emitting element, and an electrical connector 904. However, in this embodiment, the support structure 901 includes a mechanical support structure 911, such as a strap or a hook-and-loop fastener, that may be attached to a substrate 909. For example, in one embodiment, the mechanical support structure 911 may include a strap that has two ends that are fed through or around the substrate 909 and may be attached together on the opposite side of the substrate 909 from which the pixel support 902 is positioned. The two ends of the strap may then be attached using a clasp, fastener, such as Velcro®, or any other attachment mechanisms known in the art. In such an embodiment, depending on the mechanical support structure 911, the pixel module 900 may either removeably or permanently attached to the substrate.

Further, in an alternate embodiment, the mechanical support structure 911 may include a plurality of grip hooks that may be attached to the substrate 909. For example, in another embodiment, the mechanical structure 911 may include Velcro® hooks and the substrate 909 may include a material configured to attach to or receive the Velcro® hooks, such as a plurality of loops (e.g., felt or any other similar material known in the art). In such an embodiment, the Velcro® hooks of the mechanical support structure 911 may then be removeably attached to the substrate 909. Furthermore, those having ordinary skill in the art will appreciate that other methods known in the art may be used to attach a pixel module to a substrate or a display surface using a mechanical support structure.

In select embodiments disclosed herein, the pixel module may be attached to various substrates to allow the light from the light emitting elements mounted on the pixel support to be visible through or on the surface of the substrate as required so as to be visible from one side, the other side, or both sides of the substrate. For example, the substrates may be transparent, opaque, or translucent. Further, the substrate may be colored.

In select embodiments disclosed herein, the support structure may be constructed of different materials including, but not limited to, PVC, silicone rubber, plastic, polyethylene, or any other suitable material known in the art. Further, in select embodiments the support structure may be transparent, opaque, or translucent. Furthermore, in select embodiments, the support structure may be colored, have designs printed, or incorporated into its surface.

FIG. 8 shows a perspective view of a light emitting display system 820 having multiple light emitting pixel modules 800 mounted on a display surface 808 of a substrate 809 in accordance with an embodiment of the present disclosure. Similar to above, each pixel module 800 includes a support structure 801, a pixel support 802, at least one light emitting element 803, and an electrical connector. The pixel modules 800 may be mounted as required on the display surface 808 of the substrate 809 to form an array or display in any formation desired. Further, pixel modules 800 may be configured to be removeably attached to allow each pixel module 800 to be easily removed and configurable or reconfigured, into a different arrangement at any time. For example, at least one pixel module 800 may be easily removed or disattached from a particular location on the display surface of the substrate and then easily attached to another location on the display surface, thereby allowing the display system 820 to be configurable. One skilled in the art will appreciate that fixing, removing or repositioning of a pixel module 800 of the display system 820 may require no additions or modifications to the substrate 809 and may cause no damage or irreversible change to the substrate 809. However, in an alternate embodiment, the fixing of pixel modules 800 to the display surface 808 of the substrate 809 may be made permanent by using any permanent adhesive between the support structure 800 and the display surface 808 of the substrate 809.

Further, in one embodiment, the pixel system 820 may include a plurality of pixel modules 800 that are attached to the display surface of the substrate using various methods and support structures discussed above. For example, one pixel module may be attached to the display surface with a suction cup and one pixel module may be attached using an adhesive support structure. Thus, the various methods and support structures may be used in combination with one another within the pixel system.

Although various detailed and exemplary embodiments disclosed herein have been described above for purposes of illustration, the embodiments disclosed herein are not so limited. Those having ordinary skill in the art will appreciate that other shapes, sizes, construction, and configurations of the pixel modules, support structure, pixel supports, light emitting elements, and connectors may be used without departing from the scope of the invention.

Advantageously, embodiments of the present disclosure may include one or more of the following advantages. First, embodiments of the present disclosure may provide a light emitting pixel module that may be removeably attached to a substrate. As such, this enables the light emitting module to be easily disattached and then reattached to another location on the substrate. Further, embodiments of the present disclosure may provide a light emitting pixel module that may be mounted to many different types, shapes, and sizes of display surfaces. Furthermore, embodiments of the present disclosure may provide a light emitting display system that is quickly and easily configurable or reconfigurable so as to be arranged or rearranged as necessary.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

1. A light emitting pixel module comprising:
a pixel support disposed on a support structure; and
a light emitting element and an electrical connector disposed upon the pixel support, wherein the support structure is removably attached to a display surface on a first side of a substrate such that light emitted from the light emitting element is viewable from or through the substrate, and the light emitting element and the electrical connector are on the first side of the substrate.

2. The light emitting pixel module of claim 1 wherein the light emitting element comprises a plurality of light emitting elements.

3. The light emitting pixel module of claim 2 wherein the plurality of light emitting elements are light emitting diodes of different colors.

4. The light emitting pixel module of claim 2 further comprising a driver circuit electrically connected to the light emitting elements and configured to vary an intensity or color of the light emitted from the light emitting elements.

5. The light emitting pixel module of claim 1 wherein the light emitting element is disposed on a side of the pixel support facing inwards of the light emitting pixel module.

6. The light emitting pixel module of claim 1 wherein the light emitting element is disposed on a side of the pixel support facing outwards of the light emitting pixel module.

7. The light emitting pixel module of claim 1 wherein the support structure comprises one of a suction cup, an adhesive support structure, a mechanical support structure, a static cling support structure, and a magnetic support structure.

8. The light emitting pixel module of claim 1 wherein the support structure comprises at least one of a rubber material and a plastic material.

9. The light emitting pixel module of claim 1 wherein the support structure comprises at least one of a transparent material, a translucent material, an opaque material, a colored material, and a pre-printed design material.

10. The light emitting pixel module of claim 1 wherein the display surface comprises at least one of a transparent material, a translucent material, an opaque material, and a colored material.

11. The light emitting pixel module of claim 1 wherein the light emitting pixel module further comprises a printed circuit board.

12. The light emitting pixel module of claim 11 wherein the printed circuit board is disposed within the pixel support and the light emitting element and the electrical connector are electrically connected to the printed circuit board.

13. A light emitting display system comprising:
a plurality of light emitting pixel modules, each of the plurality of light emitting pixel modules comprising:
a support structure removably attached to a display surface;
a light emitting element mounted on a pixel support, the pixel support disposed on the support structure; and
an electrical connector disposed on the pixel support, wherein the plurality of light emitting pixel modules are arranged in a configurable display on the display surface, and the support structure covers a continuous surface of the display surface.

14. The light emitting display system of claim 13 wherein the support structure of at least one of the plurality of light emitting pixel modules comprises one of a suction cup, an adhesive support structure, a mechanical support structure, a static cling support structure, and a magnetic support structure.

15. The light emitting display system of claim 13 wherein the support structure of at least one of the plurality of light emitting pixel modules comprises a suction cup and the support structure for at least one another of the plurality of light emitting pixel modules comprises an adhesive support structure.

16. A method of attaching a light emitting element to a display surface, the method comprising:
providing a pixel module comprising a light emitting element disposed on a pixel support, the pixel support mounted on a support structure; and
removably attaching the pixel module to the display surface such that light emitted from the lighting element is viewable from the display surface, and each part of the pixel module is on a first side of the display surface.

17. The method of claim 16 wherein the light emitting element comprises a plurality of light emitting elements of the light emitting pixel module.

18. The method of claim 16 wherein the light emitting element is mounted on a side of the pixel support facing inwards of the light emitting pixel module.

19. The method of claim 18 wherein the light emitting element is viewed through the display surface.

20. The method of claim 16 wherein the light emitting element is mounted on a side of the pixel support facing outwards of the light emitting pixel module.

21. The method of claim 16 wherein the support structure comprises a suction cup.

22. The method of claim 21 further comprising using a valve disposed on the light emitting pixel module and a vacuum pump to removably attach the pixel module to the display surface.

23. A method of manufacturing a pixel module, the method comprising:
electrically connecting and attaching a light emitting element and an electrical connector to a pixel support; and
attaching the pixel support to a support structure, wherein the support structure is configured to be removably attached to a continuous portion of a display surface.

24. The method of claim 23 further comprising removably attaching the support structure of the light emitting pixel module to the display surface.

25. A light emitting pixel module comprising:
a pixel support disposed on a support structure; and
a light emitting element and an electrical connector disposed upon the pixel support;
wherein the support structure comprises one of a suction cup, an adhesive support structure, a mechanical support structure, a static cling support structure, and a magnetic support structure; and
wherein the support structure is removably attached to a display surface, and the light emitting element and the electrical connector are on a same side of the support structure.
